(19) United States
(12) Patent Application Publication
(10) Pub. No.: US 2009/0089990 A1
(43) Pub. Date: Apr. 9, 2009

(54) METHOD FOR MANUFACTURING SOLID ELECTROLYTIC CAPACITOR

(75) Inventors: Tetsuya Kawakubo, Saga (JP); Kiyoshi Itoyama, Saga (JP)

Correspondence Address: AMIN, TUROCY & CALVIN, LLP, 127 Public Square, 57th Floor, Key Tower, CLEVELAND, OH, 44114, US

(73) Assignees: SANYO ELECTRIC CO., LTD, Osaka (JP); SAGA SANYO INDUSTRIES CO., LTD., Kishima-gun (JP)

(21) Appl. No.: 12/244,248

(22) Filed: Oct. 2, 2008

(30) Foreign Application Priority Data
Oct. 4, 2007 (JP) 2007-261093

(51) Int. Cl. H01G 9/00

(52) U.S. Cl. 29/25.03

(57) ABSTRACT

A method for manufacturing a solid electrolytic capacitor comprising: successively forming a dielectric layer and a solid electrolytic layer on an anode body made of a valve metal; and forming a carbon layer on the solid electrolytic layer, wherein the carbon layer is formed by adhering a carbon solution to the solid electrolytic layer and drying the carbon solution, wherein the carbon solution contains an electrically conductive carbon, a binder resin, and a solvent and the total solid concentration of the electrically conductive carbon and the binder resin in the carbon solution is 36% by weight or more and 52% by weight or less.

### BACKGROUND OF THE INVENTION

1. Field of the Invention

The invention relates to a method for manufacturing a solid electrolytic capacitor having a carbon layer formed on a solid electrolyte layer.

2. Description of the Related Art

In recent years, along with the miniaturization and sophistication of electronic appliances, a solid electrolytic capacitor with high capacitance per product volume and low ESR (equivalent series resistance) has been required. In order to satisfy this requirement, solid electrolytic capacitors using, for example, manganese dioxide, TCNQ (7,7,8,8-tetracyanoquinodimethane) complexes, electrically conductive polymers, or the like as a solid electrolyte have been developed.

A solid electrolytic capacitor is produced by, for example, forming a dielectric layer by anodizing an anode body made of a porous sintered body of a valve metal such as tantalum; successively forming a solid electrolytic layer, a carbon layer, and a cathode lead-out layer on the dielectric layer to form a capacitor element; attaching an anode lead terminal and a cathode lead terminal to the capacitor element; and covering and sealing the resulting capacitor element with an outer resin such as an epoxy resin.

In the above-mentioned solid electrolytic layer, electrically conductive polymers such as polypyrrole, polythiophene, polyfuran, and polyaniline can remarkably contribute to decrease of ESR of an electrolytic capacitor since the electrically conductive polymers have high electric conductivity as compared with that of manganese dioxide or the like. Further, as a measure of improving the electric conductivity of the carbon layer, for example, use of electrically conductive carbon such as graphite, and carbon black was proposed. (for example, Japanese Laid-Open Patent Application Nos. 2004-228389 and 2004-221224)

Meanwhile, as a carbon film for forming an electrically conductive circuit of a printed circuit board, it has been proposed that the carbon film is formed by using a carbon type electrically conductive paste obtained by dispersing graphite and carbon black in a phenol resin in order to improve the electric conductivity. (for example, Japanese Laid-Open Patent Application No. H09-31402)

However, in a solid electrolytic capacitor, even if the electric conductivity of the above-mentioned carbon layer is improved, an insufficient durability of the solid electrolytic layer to heat stress and mechanical stress has become a problem in terms of the characteristics of the solid electrolytic capacitor. That is, in the production process of the solid electrolytic capacitor, at the time of forming the cathode lead-out layer using a silver paste or carrying out outer resin molding, stress is applied to the solid electrolytic layer due to shrinkage of respective materials by heat stress or mechanical stress, whereby the solid electrolytic layer can be deteriorated. Further, not only in the production process, but also in a soldering process for mounting the electrolytic capacitor on a substrate, stress is applied similarly to the solid electrolytic layer due to heat stress after completion of the electrolytic capacitor, whereby the solid electrolytic layer can be deteriorated. Therefore, even if the electric conductivity of the carbon layer is improved, the solid electrolytic layer is deteriorated due to such stresses, whereby a problem of increasing ESR of the solid electrolytic capacitor is caused. Particularly, in a case where a solid electrolytic layer contains an electrically conductive polymer, it considerably contributes to decrease of ESR of the solid electrolytic capacitor as described above and thus, deterioration of the solid electrolytic layer greatly affects on ESR.

### SUMMARY OF THE INVENTION

In view of the above-mentioned problem, an object of the invention to provide a method for manufacturing a solid electrolytic capacitor which makes it possible to moderate stress applied to a solid electrolytic layer by heat stress and mechanical stress and to suppress increase of ESR.

According to one aspect of the present invention, there is provided a method for manufacturing a solid electrolytic capacitor comprising:

successively forming a dielectric layer and a solid electrolytic layer on an anode body made of a valve metal; and

forming a carbon layer on the solid electrolytic layer,

wherein the carbon layer is formed by adhering a carbon solution to the solid electrolytic layer and drying the carbon solution,

wherein the carbon solution contains an electrically conductive carbon, a binder resin, and a solvent and the total solid concentration of the electrically conductive carbon and the binder resin in the carbon solution is 36% by weight or more and 52% by weight or less.

Other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a cross-sectional view showing a configuration of a solid electrolytic capacitor according to one embodiment of the invention;

FIG. 2 is a graph showing ESRs before and after a heat resistant test for solid electrolytic capacitors obtained in Examples 1 to 4 and Comparative Examples 1 to 4; and

FIG. 3 is a graph showing alteration ratios of ESRs before and after a heat resistant test for the solid electrolytic capacitors obtained in Examples 1 to 4 and Comparative Examples 1 to 4.

### DETAILED DESCRIPTION OF THE PREFERRED EMBODIMENTS

The best mode for carrying out the invention is described below.

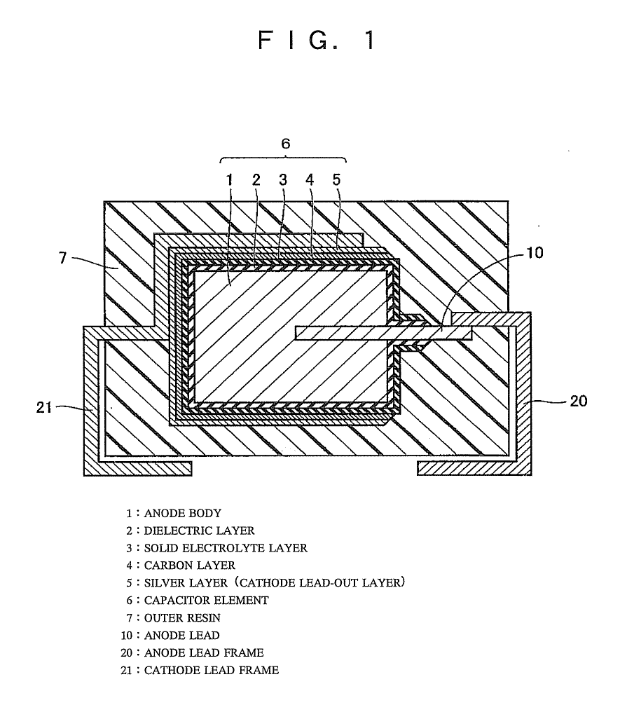

FIG. 1 is a cross-sectional view showing a configuration of a solid electrolytic capacitor according to one embodiment of the invention. A solid electrolytic capacitor according to one embodiment of the present invention has a capacitor element 6 including an anode body 1 having an anode lead 10, and a dielectric film 2, a solid electrolyte layer 3, a carbon layer 4, and a cathode lead layer 5 that are sequentially formed on the anode body 1. An anode lead frame 20 and a cathode lead frame 21 are connected to the capacitor element 6. The capacitor element 6 is covered and sealed with an outer resin 7 such as an epoxy resin.

An anode body 1 is made of a porous sintered body of a valve metal such as aluminum, tantalum, niobium, titanium, zirconium or hafnium, a surface roughened valve metal foil, or the like.

A solid electrolytic layer 3 includes, an electrically conductive polymer containing, as a main component, polypyrrole, polythiophene, polyfuran, polyaniline, or the like, or manganese dioxide, or the like. Since an electrically conductive polymer has a high electric conductivity and can considerably contribute to decrease of ESR of an electrolytic capacitor as compared with manganese dioxide, or the like, it is preferable to form a solid electrolytic layer 3 containing an electrically conductive polymer.

A carbon layer 4 contains a mixture of, for example, an electrically conductive carbon such as graphite, and carbon black, and a binder resin or the like.

A cathode lead-out layer 5 is formed from a silver paste obtained by mixing, for example, silver particles, protection colloid, and a solvent. In this connection, the cathode lead-out layer 5 may be formed from a metal paste containing other metal particles other than silver particles.

The method for manufacturing the solid electrolytic capacitor with the above-mentioned configuration will be described.

At first, an anode body 1 obtained by following manner is anodized in an aqueous phosphoric acid solution or the like to form a dielectric layer 2 on the anode body surface. The anode body 1 is formed by press-molding a powder of a valve metal implanted with an anode lead 10 to form a shaped member, and sintering the shaped member to form a porous sintered body. After formation of the dielectric layer 2, a solid electrolytic layer 3 of an electrically conductive polymer is formed on the dielectric layer 2 by chemical oxidative polymerization or electrolytic oxidative polymerization. The solid electrolytic layer 3 may be formed from manganese dioxide obtained by thermal decomposition of a manganese nitrate solution. Further, in a case where the electrically conductive polymer is formed by electrolytic oxidative polymerization, a precoat layer made of an electrically conductive polymer formed by chemical oxidative polymerization or manganese dioxide may be previously formed on the dielectric layer 2.

Next, the carbon layer 4 is formed on the solid electrolytic layer 3 by applying a carbon solution containing a dispersed electrically conductive carbon to the element in which the solid electrolytic layer 3 is formed and drying the carbon solution. As a method for forming this carbon layer 4, for example, immersion treatment, according to which the element having the solid electrolytic layer 3 is immersed in the above-mentioned carbon solution for 1 to 60 seconds and thereafter the element is heat-dried (drying by heating at a temperature of 110° C. to 120° C. for about 10 to 15 minutes) or dried at normal temperature, is repeated once or several times. Alternatively, coating treatment, according to which the above-mentioned carbon solution is coated onto the solid electrolytic layer 3 of the element and thereafter the element is heat-dried or dried at normal temperature, may be carried out once or repeated several times.

The composition of the above-mentioned carbon solution at least contains an electrically conductive carbon, a binder resin, and a solvent. The carbon solution is prepared by weighing each compositions in such a manner that the total solid concentration of the electrically conductive carbon and the binder resin in the carbon solution is within a range of 36% by weight or more and 52% by weight or less, preferably 40% by weight or more and 47% by weight or less. That is, if the total solid concentration of the electrically conductive carbon and the binder resin is within a range of 36% by weight or more and 52% by weight or less, the density of the electrically conductive carbon and the binder resin contained in the carbon layer 4 after formation of the carbon layer 4 can be made high. This carbon layer 4 having the high density of the electrically conductive carbon and the binder resin can absorb and moderate the stress applied to the solid electrolytic layer 3 when heat stress and mechanical stress are applied to the solid electrolytic layer 3. Accordingly, the deterioration of the solid electrolytic layer 3 by the heat stress and the mechanical stress during production process after formation of the carbon layer 4 and soldering process in which a solid electrolytic capacitor is soldered to a substrate can be suppressed and thus, increase of ESR of the solid electrolytic capacitor can be suppressed. If the above-mentioned total solid concentration is less than 36% by weight, it will be possible that the contact surface area of the solid electrolytic layer 3 and the carbon layer 4 is decreased, whereby ESR tends to increase. On the other hand, if the total solid concentration exceeds 52% by weight, it will be possible that the viscosity of the carbon solution containing the electrically conductive carbon and the binder resin is significantly increased and the electrically conductive carbon becomes hard to be adhered to fine parts of the solid electrolytic layer 3, whereby ESR tends to increase.

As the electrically conductive carbon contained in the carbon solution, a mixture of graphite and carbon black at a mixing weight ratio of 1:1 is preferable to be used. According to the above weight ratio, graphite and carbon black are uniformly dispersed, whereby carbon black with a smaller particle diameter can enter between particles of graphite with a larger particle diameter. As a result, it is made possible to heighten the adhesive force and hiding property of the carbon layer 4 and thus, the electric conductivity of the carbon layer 4 can be improved.

As the binder resin contained in the carbon solution, a thermosetting resin such as a phenol resin, an epoxy resin, and a melamine resin may be used. Among them, in terms of excellent heat resistance and economical property, a phenol resin is preferably used. Use of the binder resin containing the thermosetting resin can prevent softening of the binder resin even if heat is applied to the carbon layer 4 after formation of the carbon layer 4 and thus, stress applied to the solid electrolytic layer 3 can be suppressed.

The binder resin is preferably mixed at a weight ratio of 40% by weight or more and 45% by weight or less with respect to the total solid amount of the electrically conductive carbon and the binder resin, and more preferably at a weight ratio of about 43% by weight. If the content of the binder resin is within the above range, the electric conductivity of the carbon layer 4 is not lowered and the solid electrolytic layer 3 is well protected from heat stress and mechanical stress.

As the solvent contained in the carbon solution, for example, an organic solvent is preferable to be used. Use of the organic solvent makes it possible to well dissolve the binder resin in the carbon solution and evenly disperse the electrically conductive carbon in the binder resin. Accordingly, the electric conductivity of the carbon layer 4 can be improved. The organic solvent is not particularly limited if it can dissolve the binder resin therein and, for example, butyl carbitol, 1-butanol, butyl glycol acetate, and the like are preferable to be used. Among them, butyl glycol acetate is preferably used for adjusting the total solid concentration. Butyl glycol acetate is more preferably used at a weight ratio of 16% by weight or more and 38% by weight or less with respect to the total amount of the carbon solution. If the weight ratio of butyl glycol acetate is within the above range, the dispersibility of the electrically conductive carbon and the binder resin in the carbon solution can be improved and accordingly, the electric conductivity of the carbon layer 4 can be increased and ESR of the electrolytic capacitor can be lowered.

After the carbon layer 4 is formed in the above-mentioned manner, a cathode lead-out layer 5 is formed on the carbon layer 4 by immersion treatment with a silver paste or the like to produce a capacitor element 6. Thereafter, a cathode lead terminal 21 is connected to the cathode-lead out layer 5 of the capacitor element 6 with an electrically conductive adhesive or the like and an anode lead terminal 20 is connected to an anode lead 10. Then, the capacitor element 6 is covered and sealed with an outer resin such as an epoxy resin or the like in such a manner that end parts of the cathode lead terminal 21 and the anode lead terminal 20 are exposed outside, and aging treatment is carried out to complete the solid electrolytic capacitor shown in FIG. 1.

A method for manufacturing a solid electrolytic capacitor according to the invention is not limited to the method described above, and various applications or modifications are possible within the literal or equivalent scope of the claims.

Hereinafter, the present invention will be described more in detail with reference to Examples. The present invention, however, is not limited to them.

### EXAMPLE

### Example 1

After a dielectric layer made of an oxide film was formed on the surface of an anode body made of a tantalum porous sintered body by carrying out chemical conversion treatment of anodization in a phosphoric acid solution, chemical oxidative polymerization process, according to which the anode body having the dielectric layer was immersed in a mixed solution of 3,4-ethylenedioxythiophene, ferric p-toluenesulfonate, and 1-butanol and thereafter dried, was repeated several times to produce an element having a solid electrolytic layer of poly(3,4-ethylenedioxythiophene) formed on the dielectric layer.

Next, a carbon solution having the total solid concentration adjusted to be 36% by weight was prepared by dispersing graphite, carbon black, and a phenol resin in an organic solvent containing butyl carbitol, 1-butanol, and butyl glycol acetate. Then, the above-obtained element was immersed in the carbon solution and dried to form a carbon layer on the solid electrolytic layer.

After the element having the carbon layer was immersed in a silver paste to form a capacitor element having a cathode lead-out layer formed on the carbon layer, electrode terminals were attached to the capacitor element. Then, the capacitor element was molded by transfer molding with an epoxy resin, and aging treatment were carried out to complete a solid electrolytic capacitor with a rated voltage of 25 V and a nominal capacitance of 15 μF.

### Example 2

A solid electrolytic capacitor was produced in the same manner as in Example 1, except that in formation of the carbon layer, the immersion treatment was carried out using a carbon solution adjusted to have 40% by weight of the total solid concentration.

### Example 3

A solid electrolytic capacitor was produced in the same manner as in Example 1, except that in formation of the carbon layer, the immersion treatment was carried out using a carbon solution adjusted to have 47% by weight of the total solid concentration.

### Example 4

A solid electrolytic capacitor was produced in the same manner as in Example 1, except that in formation of the carbon layer, the immersion treatment was carried out using a carbon solution adjusted to have 52% by weight of the total solid concentration.

### Comparative Example 1

A solid electrolytic capacitor was produced in the same manner as in Example 1, except that in formation of the carbon layer, the immersion treatment was carried out using a carbon solution adjusted to have 29% by weight of the total solid concentration.

### Comparative Example 2

A solid electrolytic capacitor was produced in the same manner as in Example 1, except that in formation of the carbon layer, the immersion treatment was carried out using a carbon solution adjusted to have 32% by weight of the total solid concentration.

### Comparative Example 3

A solid electrolytic capacitor was produced in the same manner as in Example 1, except that in formation of the carbon layer, the immersion treatment was carried out using a carbon solution adjusted to have 58% by weight of the total solid concentration.

After preparation of the carbon solution in the respective Examples and Comparative Examples, actual measured values of the contents of each composition in the carbon solutions were measured. The results are shown in Table 1. Since the values of the respective compositions in Table 1 are actual measured values in consideration of essential figure, they are slightly different from values calculated from the respective composition concentrations at the time of preparing the carbon solutions.

TABLE 1

| | | | | | | Butyl |
|---|---|---|---|---|---|---|
| | | Carbon | Phenol | Butyl | | glycol |
| | Graphite | Black | Resin | carbitol | 1-Butanol | acetate |
| Ex. 1 | 10.9 | 10.9 | 16.3 | 16.3 | 8.1 | 37.5 |
| Ex. 2 | 12.4 | 12.4 | 18.6 | 18.6 | 9.3 | 28.6 |
| Ex. 3 | 13.4 | 13.4 | 20.1 | 20.1 | 10.0 | 23.1 |
| Ex. 4 | 14.5 | 14.5 | 21.7 | 21.7 | 10.9 | 16.7 |
| C. Ex. 1 | 8.7 | 8.7 | 13.1 | 13.1 | 6.5 | 50.0 |
| C. Ex. 2 | 9.7 | 9.7 | 14.5 | 14.5 | 7.2 | 44.4 |
| C. Ex. 3 | 15.8 | 15.8 | 23.7 | 23.7 | 11.9 | 9.1 |
| C. Ex. 4 | 17.4 | 17.4 | 26.9 | 26.9 | 13.04 | 0.0 |

Values are expressed in terms of wt %.

### (Evaluation)

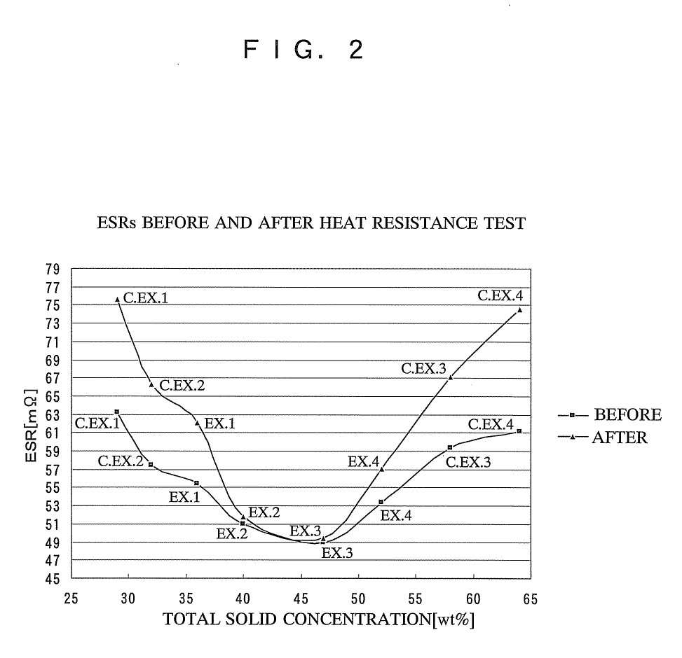

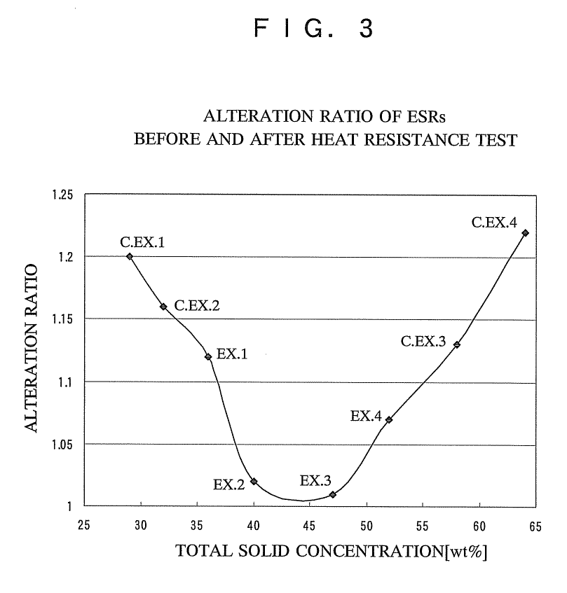

Each of 200 solid electrolytic capacitors was produced in respective Examples and Comparative Examples. These solid electrolytic capacitors were subjected to the measurements of ESR at the initial stage (immediately after aging treatment) and ESR after the heat resistance test (VPS test: subjecting to heating at 235° C. for 75 seconds twice) at a measurement frequency of 100 Hz, and the average values and the alteration ratios of ESRs before (at initial stage) and after the heat resistance test were calculated. Further, formation states of the carbon layers were observed before molding the outer resins. These samples were determined to be “Good”, if the carbon layers were formed uniformly, and to be “Bad”, if the carbon layers were formed unevenly. The results are shown in Table 2. FIG. 2 shows the graph showing ESRs before and after the heat resistance test in the respective Examples and Comparative Examples and FIG. 3 shows the graph showing alteration ratios of ESRs before and after the heat resistance test in the respective Examples and Comparative Examples.

TABLE 2

| | Total Solid | | ESR(mΩ) | | |
|---|---|---|---|---|---|
| | Concentration in | | Before Heat | After Heat | Alteration Ratio |
| | Carbon solution | Formation state | Resistance | Resistance | of ESRs |
| | (wt %) | of Carbon Layer | Test | Test | [After/Before] |
| C. Ex. 1 | 29 | Good | 63.2 | 75.6 | 1.20 |
| C. Ex. 2 | 32 | Good | 57.4 | 66.3 | 1.16 |
| Ex. 1 | 36 | Good | 55.4 | 62.1 | 1.12 |
| Ex. 2 | 40 | Good | 51.0 | 51.8 | 1.02 |
| Ex. 3 | 47 | Good | 48.9 | 49.4 | 1.01 |
| Ex. 4 | 52 | Good | 53.4 | 57.1 | 1.07 |
| C. Ex. 3 | 58 | Bad | 59.4 | 67.1 | 1.13 |
| C. Ex. 4 | 64 | Bad | 61.2 | 74.6 | 1.22 |

As shown in Table 2 and graphs of FIGS. 2 and 3, the solid electrolytic capacitors of Examples 1 to 4 produced by using the carbon solutions having the total solid concentrations of 36% by weight or more and 52% by weight or less, showed that alteration ratios of ESRs before and after the heat resistance test were remarkably suppressed, as compared with those of Comparative Examples 1 and 2 produced by using the carbon solutions having the total solid concentrations of less than 36% by weight and those of Comparative Examples 3 and 4 produced by using the carbon solutions having the total solid concentrations of more than 52% by weight. Moreover, it is found that the solid electrolytic capacitors of Examples 1 to 4 have low ESRs both of before and after the heat resistance test, as compared with those of the respective Comparative Examples. Particularly, the solid electrolytic capacitors of Examples 2 and 3 produced by using the carbon solutions having the total solid concentrations of from 40 to 47% by weight showed excellent properties; i.e. alteration ratio of ESRs before and after the heat resistance test and ESRs both of before and after the heat resistance test were further improved.

These results show that, in a case where a carbon layer is formed by using a carbon solution having the total solid concentration of from 36 to 52% by weight at the time of formation of the carbon layer, the density of the electrically conductive carbon (the mixture of graphite and carbon black) and the binder resin contained in the formed carbon layer is increased and this carbon layer can absorb and moderate the stress to be applied to the solid electrolytic layer at the time of application of heat stress and mechanical stress. Therefore, deterioration of the solid electrolytic layer due to the heat stress and the mechanical stress in the production process and the heat resistance test after formation of the carbon layer is prevented, and as a result, it is supposed that increase of ESR of the solid electrolytic capacitor can be suppressed.

As described above in detail, according to one aspect of the present invention, there is provided a method for manufacturing a solid electrolytic capacitor comprising:

successively forming a dielectric layer and a solid electrolytic layer on an anode body made of a valve metal; and

forming a carbon layer on the solid electrolytic layer,

wherein the carbon layer is formed by adhering a carbon solution to the solid electrolytic layer and drying the carbon solution,

wherein the carbon solution contains an electrically conductive carbon, a binder resin, and a solvent and the total solid concentration of the electrically conductive carbon and the binder resin in the carbon solution is 36% by weight or more and 52% by weight or less.

According to the above method, the density of the electrically conductive carbon and the binder resin contained in the carbon layer after formation of the carbon layer can be increased and this carbon layer can absorb and moderate the stress to be applied to the solid electrolytic layer at the time of application of heat stress and mechanical stress. Consequently, deterioration of the solid electrolytic layer by the heat stress and the mechanical stress in a production process and soldering process for mounting the electrolytic capacitor on a substrate after formation of the carbon layer can be prevented, whereby increase of ESR of the solid electrolytic capacitor can be suppressed.

In the above-described method, the electrically conductive carbon is preferable to contain a mixture of graphite and carbon black. According to the method, graphite and carbon black are evenly dispersed, whereby the electric conductivity of the carbon layer can be improved.

In the above-described method, the solvent is preferable to contain an organic solvent. According to the method, the binder resin is well dissolved in the carbon solution and the electrically conductive carbon can evenly be dispersed in the binder resin.

Further, in the above-described method, the organic solvent is preferable to contain butyl glycol acetate. According to the method, the dispersibility of the electrically conductive carbon and binder resin in the carbon solution can be further improved.

In the above-described method, the binder resin is preferable to contain a thermosetting resin. According to the method, even if heat is applied after formation of the carbon layer, the binder resin is not softened and stress applied to the solid electrolytic layer can be suppressed and deterioration of the solid electrolytic layer can be prevented.

In the above-described method, the carbon layer is preferable to be formed on the solid electrolytic layer containing an electrically conductive polymer. According to the method, it can greatly contribute to decrease of ESR of the solid electrolytic capacitor.

As described above in detail, according to the present invention, ESR alteration due to the effect of stress in the production process and soldering process can be lessened and the solid electrolytic capacitor with low ESR and stably keeping the low ESR can be produced.

The present application claims a priority based on Japanese Patent Application No. 2007-261093 filed on Oct. 4, 2007, the contents of which are hereby incorporated by reference in its entirely.

Although the present invention has been described in detail, the foregoing descriptions are merely exemplary at all aspects, and do not limit the present invention thereto. It should be understood that an enormous number of unillustrated modifications may be assumed without departing from the scope of the present invention.

What is claimed is:

1. A method for manufacturing a solid electrolytic capacitor comprising:
successively forming a dielectric layer and a solid electrolytic layer on an anode body made of a valve metal; and
forming a carbon layer on the solid electrolytic layer,
wherein the carbon layer is formed by adhering a carbon solution to the solid electrolytic layer and drying the carbon solution,
wherein the carbon solution contains an electrically conductive carbon, a binder resin, and a solvent and the total solid concentration of the electrically conductive carbon and the binder resin in the carbon solution is 36% by weight or more and 52% by weight or less.

2. The method for manufacturing a solid electrolytic capacitor according to claim 1, wherein the electrically conductive carbon contains a mixture of graphite and carbon black.

3. The method for manufacturing a solid electrolytic capacitor according to claim 1, wherein the solvent contains an organic solvent.

4. The method for manufacturing a solid electrolytic capacitor according to claim 3, wherein the organic solvent contains butyl glycol acetate.

5. The method for manufacturing a solid electrolytic capacitor according to claim 1, wherein the binder resin contains a thermosetting resin.

6. The method for manufacturing a solid electrolytic capacitor according to claim 1, the carbon layer is formed on the solid electrolytic layer containing an electrically conductive polymer.

7. The method for manufacturing a solid electrolytic capacitor according to claim 1, wherein a weight ratio of the binder resin with respect to the total solid amount of the electrically conductive carbon and the binder resin is 40% by weight or more and 45% by weight or less.

8. The method for manufacturing a solid electrolytic capacitor according to claim 4, wherein a weight ratio of butyl glycol acetate in the carbon solution is 16% by weight or more and 38% by weight or less.
